(19) United States
(12) Patent Application Publication
(10) Pub. No.: US 2011/0202559 A1
(43) Pub. Date: Aug. 18, 2011

(54) AUTOMATED CATEGORIZATION OF SEMI-STRUCTURED DATA

(75) Inventor: Todd Stiers, Berkeley, CA (US)

(73) Assignee: MobiTV, Inc., Emeryville, CA (US)

(21) Appl. No.: 12/708,370

(22) Filed: Feb. 18, 2010

(51) Int. Cl. G06F 17/30

(52) U.S. Cl. 707/771; 707/E17.014

(57) ABSTRACT

Mechanisms are provided for generating an inverse vector space search engine to automatically categorize and/or tag semi-structured data. In particular examples, an inverse vector space search engine includes multiple genres each associated with multiple keywords. Metadata such as media content description, caption information, review information, etc., are identified to determine distance between the media content and the various genres. Genres having a closer distance to media content are determined to be genres more closely describing the media content. Post filtering, alternate category determination, and user profiling may also be applied to the results.

### DESCRIPTION OF RELATED ART

The present disclosure relates to techniques and mechanisms for automatically categorizing semi-structured data.

### DESCRIPTION OF RELATED ART

It is often desirable to categorize different data found in specific contexts. For example, it may be useful to categorize data corresponding to different products, media, individuals, etc. However, categorization of data is still often performed by data providers or consumers and can often be an inefficient and error prone process. Some efforts have been made to automatically categorize data, but conventional automated categorization mechanisms are limited.

Consequently, the techniques and mechanisms of the present invention provide improved mechanisms for automated categorization of semi-structured data.

### OVERVIEW

Mechanisms are provided for generating an inverse vector space search engine to automatically categorize and/or tag semi-structured data. In particular examples, an inverse vector space search engine includes multiple genres each associated with multiple keywords. Metadata such as media content description, caption information, review information, etc., are identified to determine distance between the media content and the various genres. Genres having a closer distance to media content are determined to be genres more closely describing the media content. Post filtering, alternate category determination, and user profiling may also be applied to the results.

These and other features of the present invention will be presented in more detail in the following specification of the invention and the accompanying figures, which illustrate by way of example the principles of the invention.

### BRIEF DESCRIPTION OF THE DRAWINGS

The disclosure may best be understood by reference to the following description taken in conjunction with the accompanying drawings, which illustrate particular embodiments of the present invention.

FIG. 1 illustrates a particular example of a vector space search engine.

FIG. 2 illustrates a particular example of an inverse vector space search engine.

FIG. 3 illustrates a network that can use an inverse vector space search engine.

FIG. 4 illustrates one example of a media content delivery system.

FIG. 5 illustrates a technique for applying an inverse vector space search engine.

FIG. 6 illustrates a technique for generating an inverse vector space search matrix.

FIG. 7 illustrates a particular example of a computer system.

### DESCRIPTION OF PARTICULAR EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques of the present invention will be described in the context of particular types of media data and particular categories. However, it should be noted that the techniques and mechanisms of the present invention can be used to categorize a variety of types of data and not just semi-structured data and/or media data. In the following description, numerous specific details are set forth in order to provide a thorough understanding of the present invention. The present invention may be practiced without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a processor is used in a variety of contexts. However, it will be appreciated that multiple processors can also be used while remaining within the scope of the present invention unless otherwise noted. Furthermore, the techniques and mechanisms of the present invention will sometimes describe two entities as being connected. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

A “vector space search engine” (VSSE) is a tool/mechanism used in many modern search engines. In this technique, each page or document is entered into the search engine as a vector, where each unique word becomes a column in a matrix common to the entire data set represented by all of the pages and documents. Each occurrence of each unique word indexes that column, and each document entry can be considered a row. Natural language processing tricks are applied to reduce the number of columns (and corresponding dimensions) in the vector space search engine matrix. Punctuation and symbols are usually stripped, capitalization is removed, plurals/common forms of words are used and some words are even blacklisted so that they are not included in the VSSE matrix. It is often desirable to minimize the size of the matrix, as storage and processing resources required can become enormous.

Like the page and/or document vectors, a query is processed as a vector in the space defined by the data set. The actual search is performed by finding the minimal multi-dimensional distance between the search vector and the page and/or document vectors. Page and/or document vectors that are closest to the search query vector are ranked higher as a closer match. Euclidean geometry and linear algebra can be used to determine distance between vectors.

The technique and mechanisms of the present invention recognize that a VSSE can be used not only to search pages or data, but can be used to categorize data. Data may include media, product information, text, etc. It is recognized that an inverse VSSE (IVSSE) can be used. Each row of an IVSSE can represent a category such as a genre. Keywords that may be associated with various categories are provided as columns. For example, row headers may include news, sports, kids, music, movies, etc. Column headers may include headlines, finance, baseball, football, action, radio, rock, pop, songs, cartoons, etc. Words, phrases, and all types of data that somehow describe the category could be included, but keywords are used here for simplicity.

To determine the best category match for a particular piece of content, information for that given content is used to construct the search vector, which is then matched for closeness to the existing categories. Returned is a ranked list of categories, where the category vectors closest to the search vector are determined to be categories that best describe the content. IVSSE's can have thresholds set that could result in no suitable matches. Because the number of possible categories is rather small, and the number of related keywords is limited, the IVSSE has a relatively small corpus as its index, making searching very rapid.

A final filtering or negative search of results can be applied to define explicitly incorrect categorization. For example, explicit words can be defined to keep a piece of content from being within a category at all. Content having adult oriented keywords would not be placed in the kids genre even if the kids category vector was extremely close to the search vector.

According to various embodiments, an IVSSE can be automatically generated by providing categorized content to an IVSSE generator. In particular embodiments, the categorized content may be numerous television dramas having caption and description information. The most frequently occurring uncommon words are used to populate columns associated with the drama genre.

According to various embodiments, a streaming server receiving content from multiple sources can automatically categorize or recategorize content using an IVSSE. Content can be categorized even if no description is provided. Media streams can be categorized using metadata such as caption information or review information. New categories may be dynamically generated and added. Multiple candidate categories for a media stream may be provided. In some examples, users are profiled based on categories most frequently selected.

In particular embodiments, media from different content providers can be aggregated into new content genres even though the different content providers did not intend to provide similar content. Cross-content provider genres can be defined using an IVSSE generator.

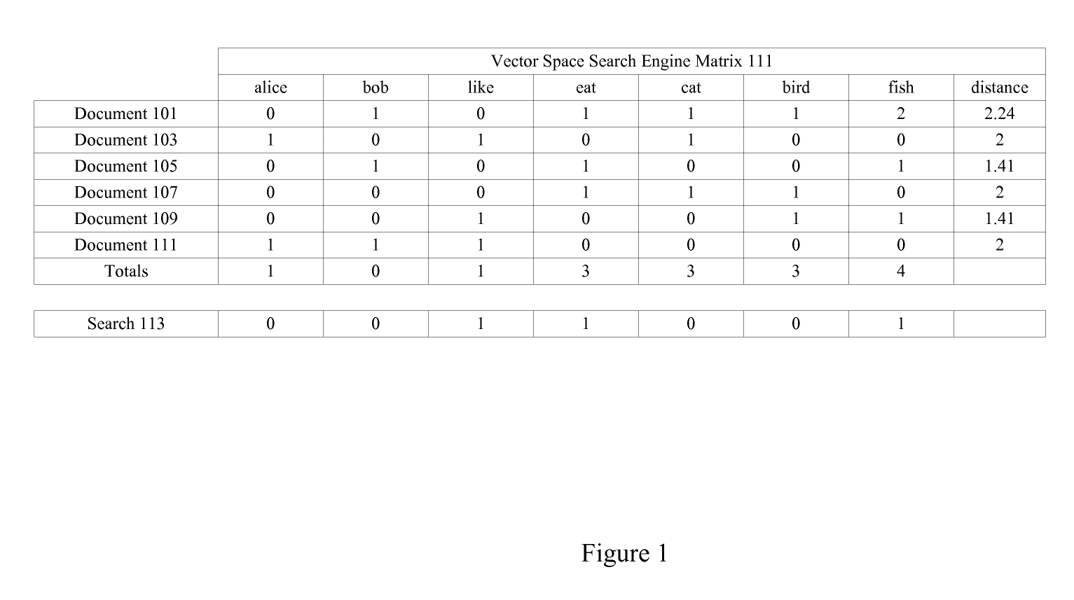

FIG. 1 illustrates one example of a vector space search engine (VSSE). According to various embodiments, each document and/or page corresponds to a row in the VSSE matrix 111. Each word or keyword in the data set corresponds to a column in the VSSE matrix. When a word or derivative of the word occurs in a document and/or page, the value in the VSSE matrix is incremented. In particular embodiments, document 101 includes the words bob, eat, cat, bird, fish. Document 103 includes the words alice, like, and cat. Document 105 includes the words bob, eat, and fish. Document 107 includes the words cat, eat, and bird. Document 109 includes the words bird, like, and fish. Document 111 includes the words alice, like, and bob. According to various embodiments, a VSSE matrix may be very sparse with numerous rows corresponding to numerous documents and other data groupings in a search space and columns corresponding to numerous words and other data included in the documents.

According to various embodiments, a variety of natural language techniques can be applied to reduce the size of a VSSE matrix. Groups of words or phrases can also be included in a single column. It is desirable to minimize the number of columns for performance, space and processing resources required can become enormous. A search query can be structured as a vector in the space defined by the data set.

The actual search is performed by finding the minimal multi-dimensional distance between the search vector and the page and/or document vectors. Page and/or document vectors that are closest to the search query vector are ranked higher as a closer match. The Pythagorean Theorem as well as optimized linear algebra techniques can be used to find the closest distance between search and document vectors.

In particular embodiments, a search query may be “who likes to eat fish.” The search vector 113 is populated with the search terms and the distance between the search vector and the various document vectors is determined. According to various embodiments, the distances between the search vector and the document vectors are determined to be 2.24, 2, 1.41, 2, 1.41, and 2 for documents 101, 103, 105, 107, 109 and 111 respectively.

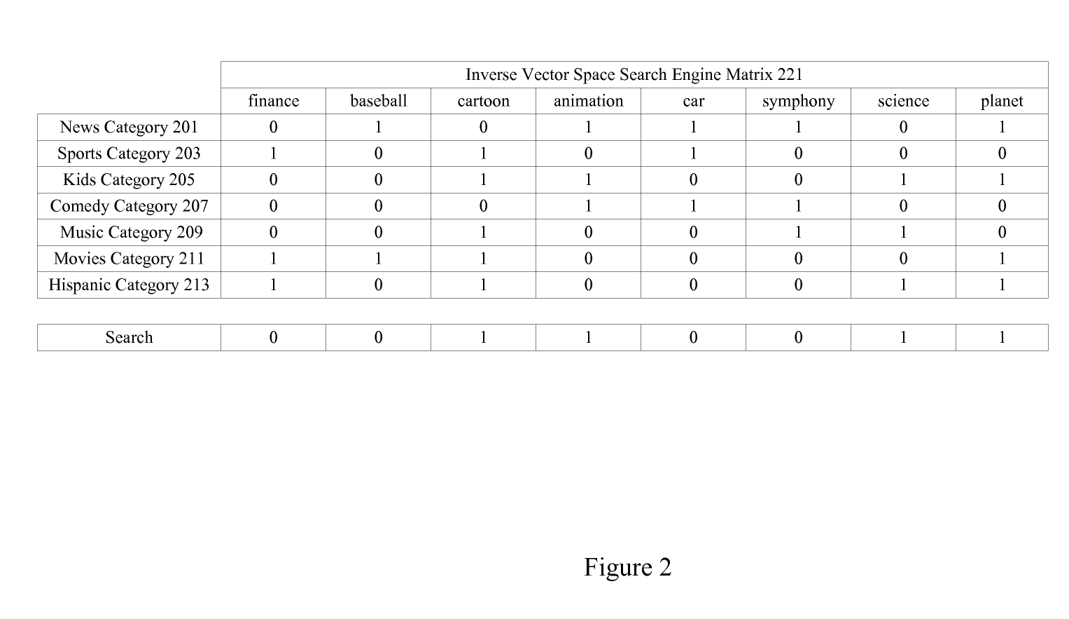

FIG. 2 illustrates one example of an inverse vector space search engine (IVSSE). According to various embodiments, it is recognized that data is often categorized manually. A variety of applications require users or content providers to place content into appropriate categories. In many instances, content can be placed in more than one category. For example, leather boots may be appropriately placed in both the category leather shoes and the category boots. Similarly, media content can be placed in more than one genre. It is often difficult to automatically determine how to place media content. In some examples, media content may come pre-categorized by a content provider. However, the categories used by a content provider may not be the ones desired by a user or other entity. For example, a content provider may group content into movies, drama, comedy, and sitcoms while a user may want more detailed categories including action movies, romantic comedies, criminal investigation dramas, medical dramas, science fiction movies, etc. In many examples, content may require categorization while the content is being received in real-time. According to various embodiments, an IVSSE accesses media content metadata such as media content description, captions, social network discussions, reviews, etc., to dynamically categorize content in real-time.

In particular embodiments, an IVSSE 221 includes rows corresponding to categories and/or genres for data groupings. Genres may include News 201, Sports 203, Kids 205, Comedy 207, Music 209, Movies 211, and Hispanic 213. Columns in the IVSSE may include keywords associated with description for media content. Keywords may include finance, baseball, cartoon, animation, car, symphony, science, and planet. In one example, a piece of media content is received. The media content includes the keywords cartoon, animation, science, and planet in its description and/or captions. The media content is then placed into the kids genre 205 based on the distance between the kids category vector and the content vector. The content can also be placed into secondary and tertiary categories based on the next closest distances.

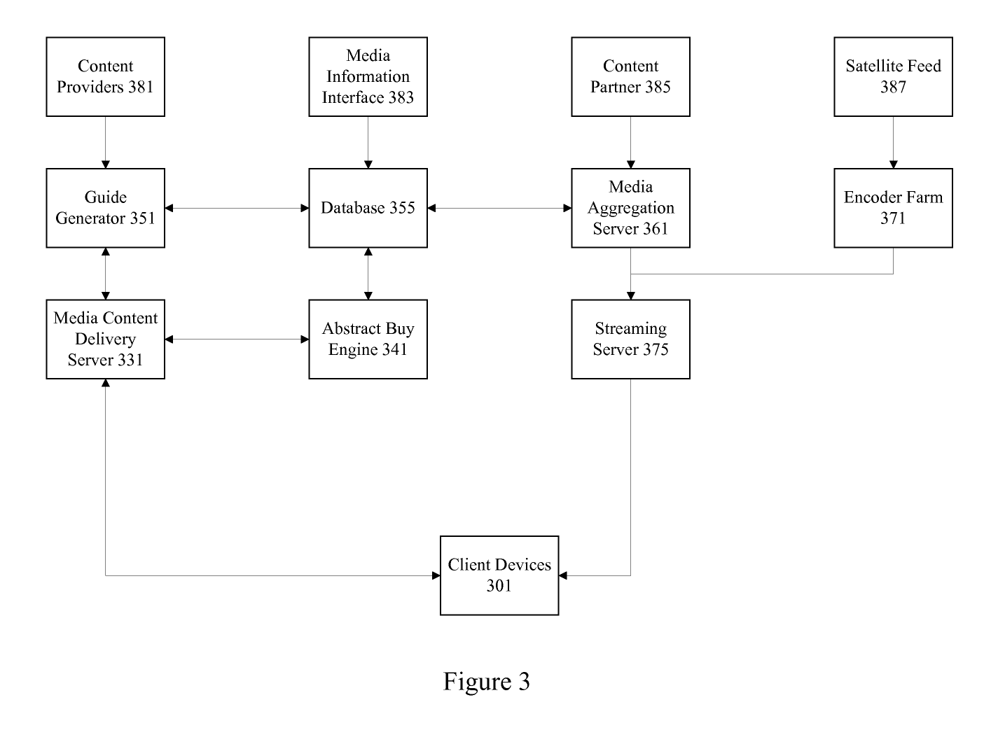

FIG. 3 is a diagrammatic representation showing one example of a network that can use the techniques of the present invention. According to various embodiments, media content is provided from a number of different sources 385. Media content may be provided from film libraries, cable companies, movie and television studios, commercial and business users, etc. and maintained at a media aggregation server 361. Any mechanism for obtaining media content from a large number of sources in order to provide the media content to mobile devices in live broadcast streams is referred to herein as a media content aggregation server. The media content aggregation server 361 may be clusters of servers located in different data centers. According to various embodiments, content provided to a media aggregation server 361 is provided in a variety of different encoding formats with numerous video and audio codecs. Media content may also be provided via satellite feed 357. According to various embodiments, media content is categorized by using an IVSSE.

An encoder farm 371 is associated with the satellite feed 387 and can also be associated with media aggregation server 361. The encoder farm 371 can be used to process media content from satellite feed 387 as well as from media aggregation server 361 into potentially numerous encoding formats. According to various embodiments, file formats include open standards MPEG-1 (ISO/IEC 11172), MPEG-2 (ISO/IEC 13818-2), MPEG-4 (ISO/IEC 14496), as well as proprietary formats QuickTime™, ActiveMovie™, and RealVideo™. Some example video codecs used to encode the files include MPEG-4, H.263, and H.264. Some example audio codecs include Qualcomm Purevoice™ (QCELP), The Adaptive Multi—Narrow Band (AMR-NB), Advanced Audio coding (AAC), and AACPlus. The media content may also be encoded to support a variety of data rates. The media content from media aggregation server 361 and encoder farm 371 is provided as live media to a streaming server 375. In one example, the streaming server is a Real Time Streaming Protocol (RTSP) server 375. Media streams are broadcast live from an RTSP server 375 to individual client devices 301. A variety of protocols can be used to send data to client devices.

Possible client devices 301 include personal digital assistants (PDAs), cellular phones, personal computing devices, personal computers etc. According to various embodiments, the client devices are connected to a cellular network run by a cellular service provider. IN other examples, the client devices are connected to an Internet Protocol (IP) network. Alternatively, the client device can be connected to a wireless local area network (WLAN) or some other wireless network. Live media streams provided over RTSP are carried and/or encapsulated on one of a variety of wireless networks.

The client devices are also connected over a wireless network to a media content delivery server 331. The media content delivery server 331 is configured to allow a client device 301 to perform functions associated with accessing live media streams. For example, the media content delivery server allows a user to create an account, perform session identifier assignment, subscribe to various channels, log on, access program guide information, obtain information about media content, etc. According to various embodiments, the media content delivery server does not deliver the actual media stream, but merely provides mechanisms for performing operations associated with accessing media. In other implementations, it is possible that the media content delivery server also provides media clips, files, and streams. The media content delivery server is associated with a guide generator 351. The guide generator 351 obtains information from disparate sources including content providers 381 and media information sources 383. The guide generator 351 provides program guides to database 355 as well as to media content delivery server 331 to provide to client devices 301.

According to various embodiments, the guide generator 351 obtains viewership information from individual client devices. In particular embodiments, the guide generation 351 compiles viewership information in real-time in order to generate a most-watched program guide listing most popular programs first and least popular programs last. The client device 301 can request program guide information and the most-watched program guide can be provided to the client device 301 to allow efficient selection of video content. According to various embodiments, guide generator 351 is connected to a media content delivery server 331 that is also associated with an abstract buy engine 341. The abstract buy engine 341 maintains subscription information associated with various client devices 301. For example, the abstract buy engine 341 tracks purchases of premium packages.

The media content delivery server 331 and the client devices 301 communicate using requests and responses. For example, the client device 301 can send a request to media content delivery server 331 for a subscription to premium content. According to various embodiments, the abstract buy engine 341 tracks the subscription request and the media content delivery server 331 provides a key to the client device 301 to allow it to decode live streamed media content. Similarly, the client device 301 can send a request to a media content delivery server 331 for a most-watched program guide for its particular program package. The media content delivery server 331 obtains the guide data from the guide generator 351 and associated database 355 and provides appropriate guide information to the client device 301.

Although the various devices such as the guide generator 351, database 355, media aggregation server 361, etc. are shown as separate entities, it should be appreciated that various devices may be incorporated onto a single server. Alternatively, each device may be embodied in multiple servers or clusters of servers. According to various embodiments, the guide generator 351, database 355, media aggregation server 361, encoder farm 371, media content delivery server 331, abstract buy engine 341, and streaming server 375 are included in an entity referred to herein as a media content delivery system.

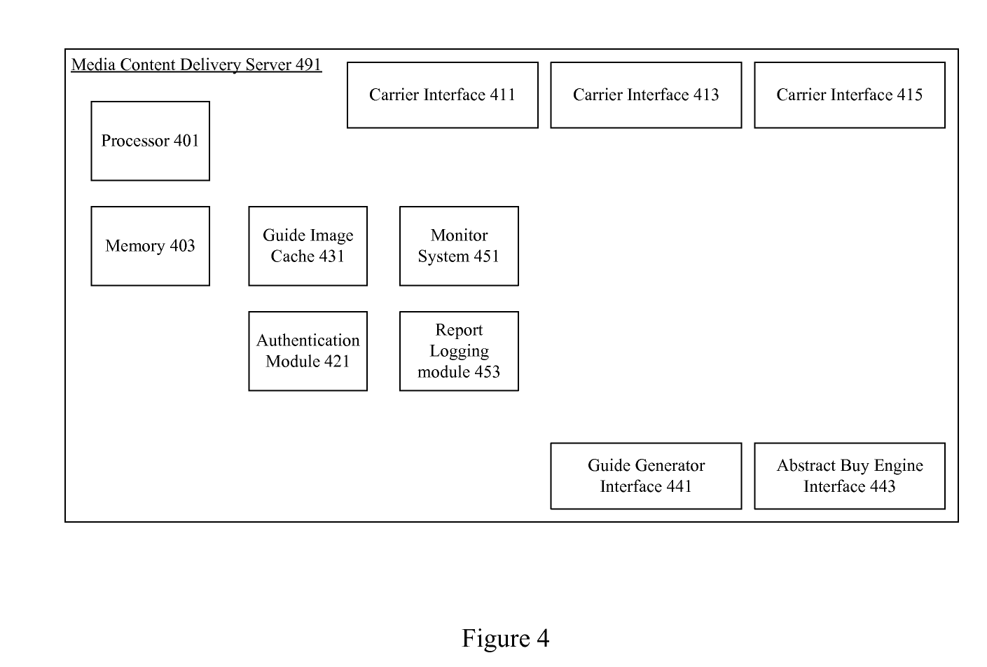

FIG. 4 is a diagrammatic representation showing one example of a media content delivery server 491. According to various embodiments, the media content delivery server 491 includes a processor 401, memory 403, and a number of interfaces. In some examples, the interfaces include a guide generator interface 441 allowing the media content delivery server 491 to obtain program guide information. The media content delivery server 491 also can include a program guide cache 431 configured to store program guide information and data associated with various channels. The media content delivery server 491 can also maintain static information such as icons and menu pages. The interfaces also include a carrier interface 411 allowing operation with mobile devices such as cellular phones operating in a particular cellular network. The carrier interface allows a carrier vending system to update subscriptions. Carrier interfaces 413 and 415 allow operation with mobile devices operating in other wireless networks. An abstract buy engine interface 443 provides communication with an abstract buy engine that maintains subscription information.

An authentication module 421 verifies the identity of mobile devices. A logging and report generation module 453 tracks mobile device requests and associated responses. A monitor system 451 allows an administrator to view usage patterns and system availability. According to various embodiments, the media content delivery server 491 handles requests and responses for media content related transactions while a separate streaming server provides the actual media streams. In some instances, a media content delivery server 491 may also have access to a streaming server or operate as a proxy for a streaming server. But in other instances, a media content delivery server 491 does not need to have any interface to a streaming server. In typical instances, however, the media content delivery server 491 also provides some media streams. The media content delivery server 491 can also be configured to provide media clips and files to a user in a manner that supplements a streaming server.

Although a particular media content delivery server 491 is described, it should be recognized that a variety of alternative configurations are possible. For example, some modules such as a report and logging module 453 and a monitor 451 may not be needed on every server. Alternatively, the modules may be implemented on another device connected to the server. In another example, the server 491 may not include an interface to an abstract buy engine and may in fact include the abstract buy engine itself. A variety of configurations are possible.

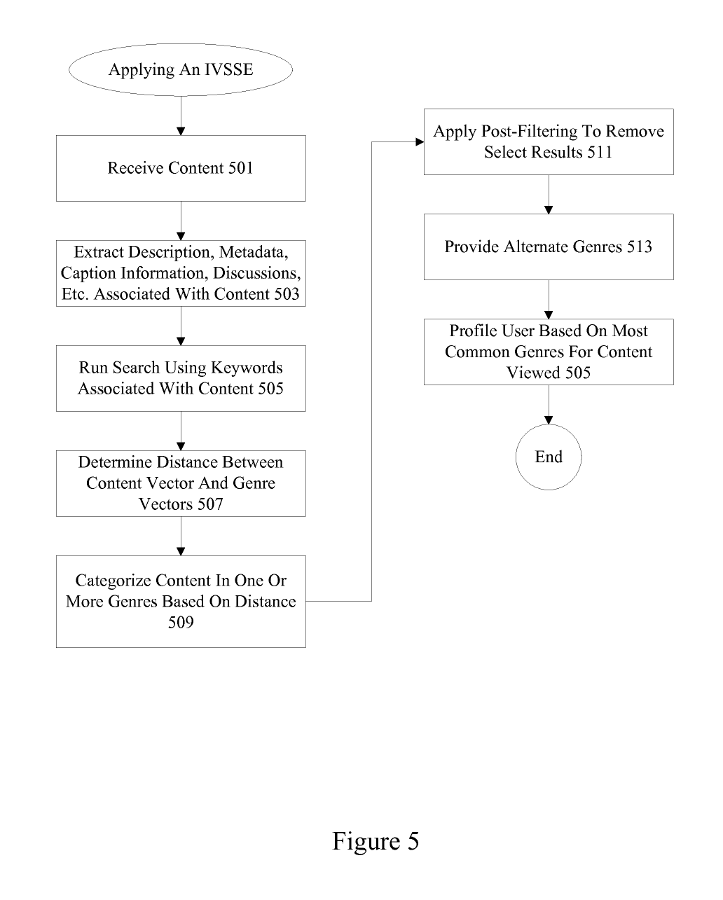

FIG. 5 illustrates one example of a technique for applying an IVSSE. At 501, media content is received. At 503, information associated with the content is extracted. According to various embodiments, metadata such as description, caption information, review information, and social networking data associated with the content is extracted and analyzed. Entire documents themselves could be used in an IVSSE. At 505, an IVSSE is used to evaluate keywords associated with the content. A subset or substantially all of the keywords from the description, captions, etc., can be used to run the IVSSE. At 507, the distances between the search vector and the genre vectors are determined. In particular embodiments, categories having the shortest distance to the search vector are determined to be the closest category matches at 509.

At 511, post filtering is applied to the results. According to various embodiments, post filtering is applied to remove clearly inappropriate categorization of content. For example, a movie about sports may be removed from a category sporting event by using a negative keyword of movie or film. In some examples, any search vector having a particular negative keyword defined by a vector associated with a genre is removed from possible categorization in that genre. At 513, a main genre as well as secondary genres are provided. According to various embodiments, users are profiled based on most frequently accessed genres at 515.

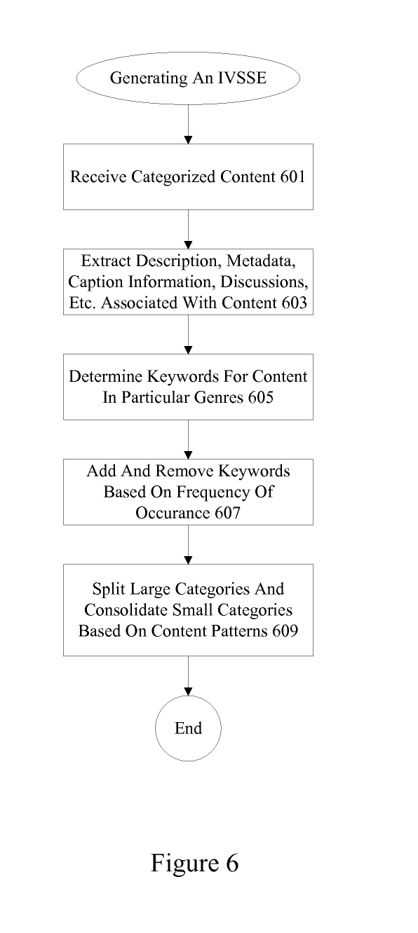

FIG. 6 illustrates one example of a system for generating an IVSSE. According to various embodiments, an IVSSE can be populated manually and subsequently used automatically to categorize content. The number of genres as well as their descriptions can be modified periodically to enhance categorization accuracy. However, it is recognized that genres and associated keywords in an IVSSE can be automatically generated.

At 601, categorized seed content is received. Categorized seed content may include content that includes descriptions and captions from a content provider. At 603, description, captions, social networking discussions, and review information associated with the content is extracted from the seed content itself or from other sources. At 605, keywords for content in particular genres are determined. According to various embodiments, keywords may include the most frequently occurring uncommon words and phrases in the seed content. Keywords are added and removed based on frequency of occurrence in the seed content at 607. At 609, large categorizes are split and small categories are combined based on content patterns. For example, infrequently occurring genres such as action comedy films and romantic action films may be combined into a genre action film. Similarly, a genre Hispanic content may be separated into Hispanic dramas and Hispanic comedies based on frequency of occurrence of various types of content.

In some examples, when the number of shows for a particular genre exceeds a maximum threshold, a genre is split into multiple genres and when the number of shows for a particular genre falls below a minimum threshold, the genre is combined into another genre automatically.

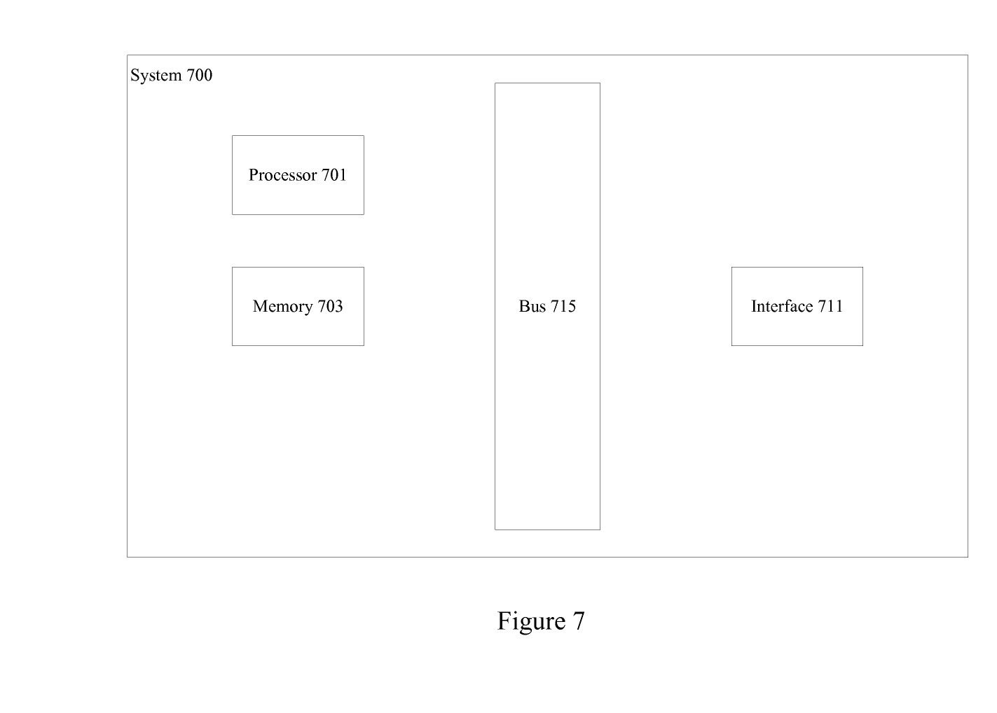

FIG. 7 illustrates one example of a server that can be used to perform categorization. According to particular embodiments, a system 700 suitable for implementing particular embodiments of the present invention includes a processor 701, a memory 703, an interface 711, and a bus 715 (e.g., a PCI bus or other interconnection fabric) and operates as a streaming server. When acting under the control of appropriate software or firmware, the processor 701 is responsible for modifying and transmitting live media data to a client. Various specially configured devices can also be used in place of a processor 701 or in addition to processor 701. The interface 711 is typically configured to end and receive data packets or data segments over a network.

Particular examples of interfaces supports include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management.

According to various embodiments, the system 700 is a content server that also includes a transceiver, streaming buffers, and a program guide database. The content server may also be associated with subscription management, logging and report generation, and monitoring capabilities. In particular embodiments, functionality for allowing operation with mobile devices such as cellular phones operating in a particular cellular network and providing subscription management. According to various embodiments, an authentication module verifies the identity of devices including mobile devices. A logging and report generation module tracks mobile device requests and associated responses. A monitor system allows an administrator to view usage patterns and system availability. According to various embodiments, the content server 791 handles requests and responses for media content related transactions while a separate streaming server provides the actual media streams.

Because such information and program instructions may be employed to implement the systems/methods described herein, the present invention relates to tangible, machine readable media that include program instructions, state information, etc. for performing various operations described herein. Examples of machine-readable media include hard disks, floppy disks, magnetic tape, optical media such as CD-ROM disks and DVDs; magneto-optical media such as optical disks, and hardware devices that are specially configured to store and perform program instructions, such as read-only memory devices (ROM) and programmable read-only memory devices (PROMs). Examples of program instructions include both machine code, such as produced by a compiler, and files containing higher level code that may be executed by the computer using an interpreter.

While the invention has been particularly shown and described with reference to specific embodiments thereof, it will be understood by those skilled in the art that changes in the form and details of the disclosed embodiments may be made without departing from the spirit or scope of the invention. It is therefore intended that the invention be interpreted to include all variations and equivalents that fall within the true spirit and scope of the present invention.

What is claimed is:

1. A method, comprising:
receiving metadata associated with media content;
generating a search vector using keywords associated with the media content;
determining a plurality distances between the search vector and a plurality of category vectors in an inverse vector space search engine matrix;
categorizing the media content using the plurality of distances between the search vector and the plurality of category vectors.

2. The method of claim 1, wherein a first category vector in the plurality of vectors includes keywords associated with the first category.

3. The method of claim 1, wherein the inverse vector space search engine matrix is automatically generated by determining commonly occurring keywords in precategorized content.

4. The method of claim 1, wherein a user is profiled based on categories of content frequently accessed.

5. The method of claim 1, wherein categorization information is provided to a user searching for content.

6. The method of claim 1, wherein the media content is assigned to a plurality of categories having the category vectors closest in distance to the search vector.

7. The method of claim 1, wherein post filtering is applied to remove media content from inappropriate categories.

8. The method of claim 7, wherein metadata comprises media content description.

9. The method of claim 7, wherein metadata comprises media content caption information.

10. The method of claim 7, wherein metadata comprises media content reviews and social networking discussions.

11. A system, comprising:
an interface configured to receive metadata associated with media content;
a processor configured to generate a search vector using keywords associated with the media content, determine a plurality distances between the search vector and a plurality of category vectors in an inverse vector space search engine matrix, and categorize the media content using the plurality of distances between the search vector and the plurality of category vectors.

12. The system of claim 11, wherein a first category vector in the plurality of vectors includes keywords associated with the first category.

13. The system of claim 11, wherein the inverse vector space search engine matrix is automatically generated by determining commonly occurring keywords in precategorized content.

14. The system of claim 11, wherein a user is profiled based on categories of content frequently accessed.

15. The system of claim 11, wherein categorization information is provided to a user searching for content.

16. The system of claim 11, wherein the media content is assigned to a plurality of categories having the category vectors closest in distance to the search vector.

17. The system of claim 11, wherein post filtering is applied to remove media content from inappropriate categories.

18. The system of claim 17, wherein metadata comprises media content description.

19. The system of claim 17, wherein metadata comprises media content caption information.

20. A computer readable storage medium having computer code embodied therein, the computer readable storage medium comprising:
computer code for receiving metadata associated with media content;
computer code for generating a search vector using keywords associated with the media content;
computer code for determining a plurality distances between the search vector and a plurality of category vectors in an inverse vector space search engine matrix;
computer code for categorizing the media content using the plurality of distances between the search vector and the plurality of category vectors.
